(19) United States
(12) Patent Application Publication
(10) Pub. No.: US 2026/0154587 A1
(43) Pub. Date: Jun. 4, 2026

(54) RESOURCE GRAPH FOR A QUANTUM COMPUTER HAVING RECONFIGURABLE QUBIT REGISTERS

(71) Applicant: IonQ, Inc., College Park, MD (US)

(72) Inventors: Vandiver CHAPLIN, Brooklyn, NY (US); Jason Madjdi AMINI, Takoma Park, MD (US)

(21) Appl. No.: 18/980,899

(22) Filed: Dec. 13, 2024

Related U.S. Application Data
(60) Provisional application No. 63/610,776, filed on Dec. 15, 2023.
(60) Provisional application No. 63/610,802, filed on Dec. 15, 2023.

(51) Int. Cl. G06N 10/20; G06F 3/06; G06N 10/40; G06N 10/60

(52) U.S. Cl. CPC G06N 10/20; G06F 3/0604; G06F 3/0658; G06F 3/0673; G06N 10/40; G06N 10/60

(57) ABSTRACT

Aspects of the present disclosure relate generally to systems, devices, methods, and computer-program products for use in the implementation and/or operation of quantum information processing (QIP) systems, and more particularly, for configuration of a resource graph for a quantum computer having reconfigurable qubit registers.

### CROSS-REFERENCE TO RELATED APPLICATIONS

This application claims the benefit of and priority to U.S. Provisional Application No. 63/610,802, filed Dec. 15, 2023, and U.S. Provisional Ser. No. 63/610,776 , filed Dec. 15, 2023, the contents of each of which applications are hereby incorporated herein by reference in their entireties.

### BACKGROUND

Aspects of the present disclosure relate generally to systems and methods for use in the implementation, operation, and/or use of quantum information processing (QIP) systems.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of techniques for optimizing the quantum resources that are used for circuit embedding in a quantum computer having reconfigurable qubit registers, and configuration of a resource graph for a quantum computer having reconfigurable qubit registers.

In an aspect of this disclosure, a computer-implemented method is provided. The computer-implemented method includes obtaining a quantum program corresponding to a defined quantum computation, where the defined quantum computation may be a multi-qubit computation; accessing a directed graph representing multiple configurations of quantum hardware and operations applicable to one or more of the multiple configurations, wherein a node in the directed graph represents a configuration of the quantum hardware, and wherein an edge in the directed graph represents one of a physical operation or a quantum mechanical operation; generating a quantum circuit by mapping the quantum program to a walk on the directed graph; and causing the quantum hardware to execute the quantum circuit by traversing the walk.

In another aspect of this disclosure computing systems (classical or otherwise) are provided to implement the foregoing computer-implemented method. More specifically, a system is provided. The system comprises at least one memory device; and at least one processor functionally coupled to the at least one memory and configured, individually or in combination, at least to: obtain a quantum program corresponding to a defined quantum computation; access a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generate a quantum circuit by mapping the quantum program to a walk of the directed graph. cause the quantum hardware to execute the quantum circuit by traversing the walk.

In yet other aspects of this disclosure, computer program products also are provided. The computer-program products have computer-executable instructions stored thereon that, in response to execution by a classical processor, causes a QIP system to perform the foregoing computer-implemented method.

In still other aspects of this disclosure, a QIP system is provided. The QIP system comprises hardware configured to support multiple parcels within a confinement section of the hardware; each one of the parcels configured to include at least one qubit; and a classical computing system functionally coupled to the hardware and comprising at least one processor configured, individually or in combination, at least to: obtain a quantum program corresponding to a defined quantum computation; access a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generate a quantum circuit by mapping the quantum program to a walk of the directed graph; and cause the quantum hardware to execute the quantum circuit by traversing the walk.

In another aspect of the disclosure, another method is provided. That method comprises configuring a resource graph for a quantum computer having reconfigurable qubit registers; and updating a control system to retain the configured resource graph for execution of a quantum program corresponding to a defined quantum computation, the control system functionally coupled to the quantum computer.

In yet another aspect of the disclosure, a computer-program product is provided. More specifically, a non-transitory computer readable medium is provided to permit or otherwise facilitate performing the method above. The non-transitory computer readable medium contains program instructions for causing a classical computer to perform or facilitate operations comprising: configuring of a resource graph for a quantum computer having reconfigurable qubit registers; and updating a control system to retain the configured resource graph for execution of a quantum program corresponding to a defined quantum computation, the control system functionally coupled to the quantum computer.

In still another aspect of this disclosure, a classical computing system is provided. The classical computing system comprises at least one memory device; and at least one processor functionally coupled to the at least one memory and configured, individually or in combination, at least to: configure a resource graph for a quantum computer having reconfigurable qubit registers; and update a control system to retain the configured resource graph for execution of a quantum program corresponding to a defined quantum computation, the control system functionally coupled to the quantum computer.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4A illustrates an example of a system in accordance with aspects of this disclosure.

FIG. 4B illustrates an example of a resource graph in accordance with aspects of this disclosure.

FIG. 5 illustrates an example of a compiled quantum circuit expressed in terms of gates between four parcels, in accordance with aspects of this disclosure.

FIG. 6 illustrates example configurations of slots, in accordance with aspects of this disclosure.

FIG. 7 illustrates an example of a walk corresponding to a compiled quantum circuit, in accordance with aspects described herein.

FIG. 8 illustrates an example of a method in accordance with aspects of this disclosure.

FIG. 9 illustrates an example of another method in accordance with aspects of this disclosure.

FIG. 10 illustrates an example of another method in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well known components.

In quantum computing, a QIP system architecture having a large number of qubits is desired in order to implement quantum computations that provide a tangible quantum advantage relative to classical computing systems. In some architectures, a large number of qubits in a trapped-atom quantum processor can be implemented in a long chain of trapped ions.

As the number of qubits needed for a quantum algorithm increases, the length of the chain needs to increase to accommodate the additional ion or ions. Increasing the length of that chain, however, results in a number of technical challenges. For example, as the length of the chain is increased, the quantum gate fidelity between pairs of qubits can be diminished by motional mode crowding and increased sensitivity to stray electric fields. This can result in reduced quantum gate fidelity between qubits, diminishing the fidelity of the quantum algorithm.

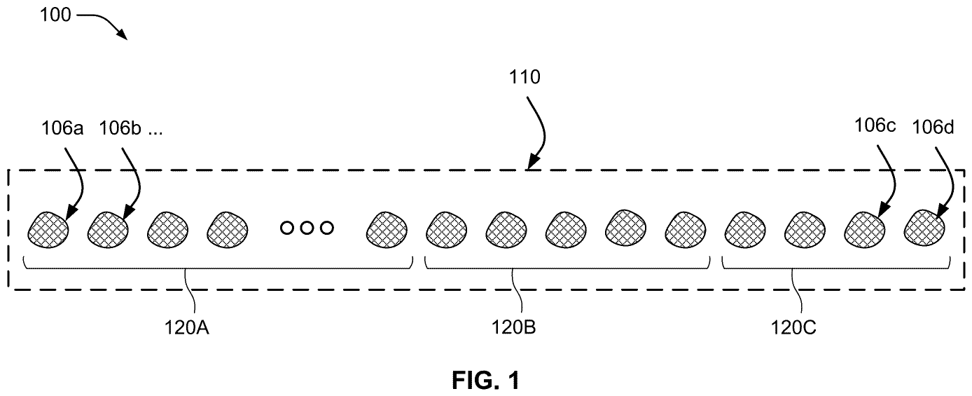

As is described in this disclosure, one solution to the issues introduced by increasing chain length includes using an architecture where the qubits are distributed into smaller chains. Such smaller chains are herein referred to as parcels. Each parcel contains a subset of all the qubits used in a quantum algorithm. A number of ions in a parcel can be, for example, 1, 2, 16, 30, with some or all of the ions configured to operate as qubits. Quantum gates between two or more qubits spanning two parcels (having same size or different size) may be implemented by merging the two parcels into one ion chain, performing the gate or gates, and then splitting the chain back into the original two parcels. By relying on parcels and resource graphs as is described in this disclosure, execution of a quantum computation using a large number of qubits can be implemented without the reduction in quantum gate fidelity that is typically present in commonplace quantum information systems using a large number of ion qubits. Aspects of embodiments of this disclosure are explained in more detail in connection with FIGS. 1-10, with FIGS. 1-3 providing context of QIP systems or quantum computers, and more specifically, of atomic-based QIP systems or quantum computers.

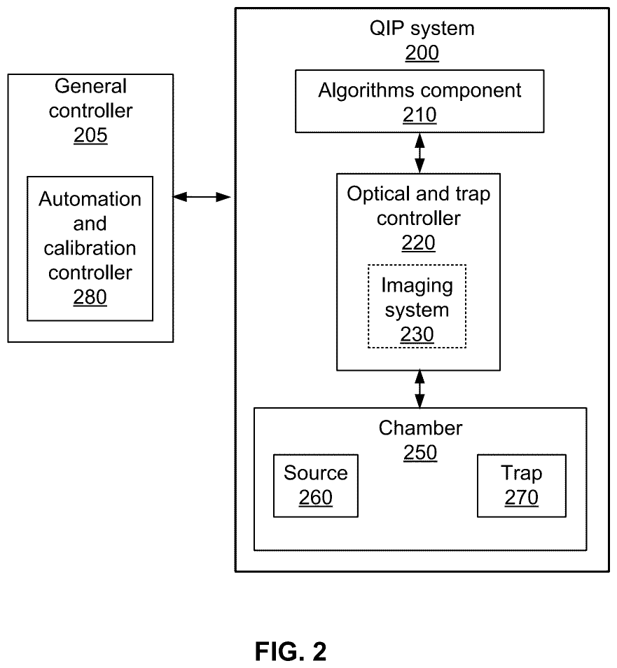

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber 250 as shown in FIG. 2). The linear chain 110 can be composed of multiple parcels 120A, 120B, 120C, each parcel containing a subset of the total ions 106 in the linear chain 110. It is noted that more of fewer than three parcels can be configured. As is used herein, a parcel refers to, and forms, an indivisible physical register that contains a defined number of confined/trapped atoms (neutral or ionized). The trap may be referred to as an ion trap. The ion trap may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

The trap includes electrodes for trapping or confining multiple ions into the chain 110, with the chain 110 laser-cooled to be nearly at rest. The number of ions trapped can be configurable and more or fewer ions may be trapped. The ions can be ytterbium ions (e.g., ¹⁷¹Yb+ions), for example. The ions can be illuminated with laser (optical) radiation tuned to a resonance in the trapped ions and the fluorescence of the ions can be imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

The chain 110 of ions 106 may be part of a QPU; that is, the chain 110 of ions 106 may be part of a processing engine or processing core of a QIP system. Some or all of the ions 106 may be configured to operate as qubits in the QIP system.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220, which controls various aspects of a trap 270 in the chamber 250, including the generation of signals to control the trap 270. Those signals may include first signals that transport the parcels within the trap 270 and second signals that merge parcels into longer chains and split those longer chains into parcels. The parcels can include, for example, parcel 120A, parcel 120B, and parcel 120C depicted in FIG. 1. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using one or more of the general controller 205, the automation and calibration controller 280, the optical and trap controller 220, and the chamber 250.

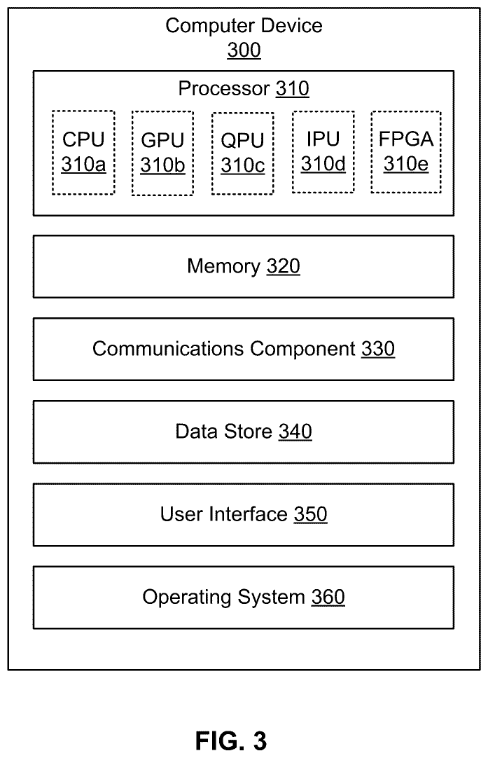

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), one or more field-programmable gate arrays (FPGAs) 310e, or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies. One or more of the QPUs 310c may be fully connected QPUs in accordance with aspects of this disclosure.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to quantum computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

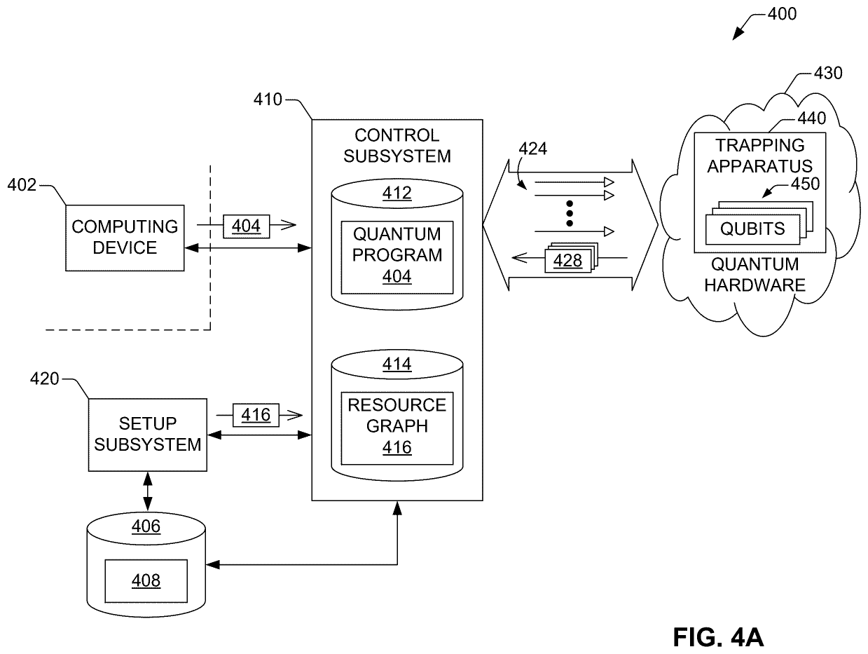

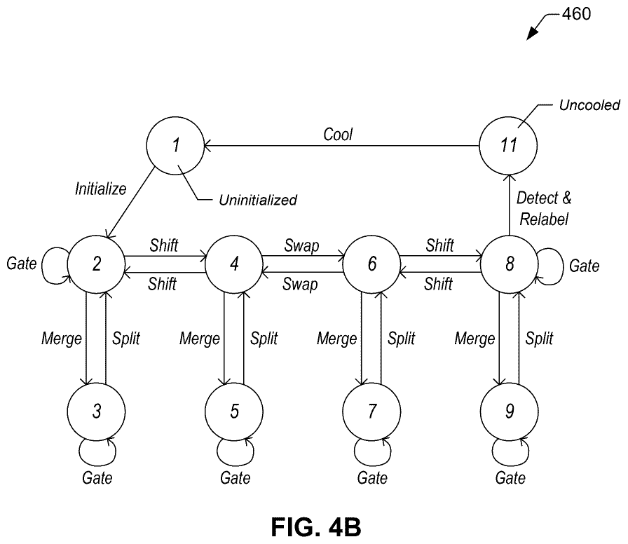

In connection with the trapped-atom systems described in FIGS. 1-3, various aspects of the technologies described herein can be implemented in the example system 400 illustrated in FIG. 4A. The example system 400 and other embodiments of the technologies of this disclosure avoid relying on a single long chain of trapped ions (or neutral atoms for that matter). This allows for quantum gates between any two qubit ions in the single chain. If a quantum gate can be implemented between two qubits that entangles the quantum state of those qubits, then those two qubits can be referred to as connected qubits. The set of all connected pairs is called the connectivity. For a single chain of ions, the connectivity contains all qubits connected to all other qubits.

Instead of a single chain, to perform a quantum computation, embodiments of the technologies of this disclosure use multiple parcels of trapped ions, each parcel containing a subset of the total qubits used in the quantum computation. Further, the embodiments implement transport of the parcels in computation to dynamically reconfigure the connectivity of the qubits. The reconfiguration includes merging pairs of parcels into a single chain to gain connectivity between all qubits in the two parcels and then separating those two parcels in preparation for the next configuration of the connectivity of the qubits. Because each parcel contains one or more qubits, each parcel constitutes a quality qubit register and the combination of multiple parcels during computation provides the computing power of a QIP system having a larger number of qubits. For example, each parcel can include 16 to 20 qubits and yet, with enough parcels, the QIP system can provide the computing power of thousands or even tens of thousands of qubits while maintaining the reliability of a 16-qubit to 20-qubit single chain QIP system. Because in some cases, parcels are pairwise connected at any given time during computation, the implementation of two-qubit gates does not change with the number of parcels. Thus, processing complexity can remain nearly unchanged as the number of qubits, and processing capacity, of a QIP system increases.

Although not illustrated in FIG. 4A, in some cases, the example system 400 can include the general controller 205 (FIG. 2) within the control subsystem 410 and the optical and trap controller 220 (FIG. 2) within quantum hardware 430. The disclosure is, of course, not limited in that respect, and the control subsystem 410 can include various modules or other types of components configured to operate in accordance with aspects of this disclosure.

More specifically, regardless of its particular architecture, the control subsystem 410 can obtain a quantum program 404 corresponding to a defined quantum computation (e.g., a multi-qubit computation). In some cases, to obtain the quantum program 404, the control subsystem 410 can receive data defining the quantum program 404 from a computing device 402. The control subsystem 410 can include one or multiple memory devices 412 (collectively referred to as memory 412) that retain the quantum program 404 that has been received from the computing device 402 or has otherwise been obtained. The quantum program 404 represents a quantum algorithm. Examples of the quantum algorithm include a variational quantum algorithm, a machine-learning algorithm, a Fourier transform algorithm, and the like.

The control subsystem 410 also can include one or multiple memory devices 414 that retain a resource graph 416. The resource graph 416 can be retained as data and/or metadata that define the resource graph 416.

The resource graph 416 is a directed graph that represents multiple configurations of functional elements that constitute the quantum hardware 430, transitions between the functional elements, and operations that can be applied to the functional elements. For purposes of illustration, the functional elements of this disclosure include atom source(s), laser devices, trap electrodes, and other equipment that permit assembling ions, including the multiple qubits 450, within a trapping apparatus 440. The transitions can include transport of one or more parcels to dynamically reconfigure the connectivity, laser cooling, state preparation, detection, or a combination thereof. The operations can include the one-qubit gate operations and two-qubit gate operations, laser cooling, state preparation, state detection, or a combination thereof. In some cases, the trapping apparatus 440 can be embodied in the chamber 250, which includes trap 270 (FIG. 2). The multiple qubits 450 can include ion qubits or neutral-atom qubits.

A node in the resource graph 416 represents a configuration of the quantum hardware 430. Such a configuration can include a spatial arrangement within the trapping apparatus 440 of multiple parcels configured in the quantum hardware 430. The configuration also can include information about each one of the multiple parcels. For example, the information can be indicative of whether a particular parcel has been laser cooled, whether the qubits in a parcel have been state prepared, whether the qubits in a parcel have been state detected, or a combination thereof. Simply for the sake of illustration, embodiments of this disclosure are described with reference to the case where the configuration represents a spatial arrangement of the parcel in the trapping apparatus 440, whether the ions have been cooled, and whether the ions have been initialized. Simply as an illustration, FIG. 4B is a diagram 460 that illustrates an example representation of the resource graph 416. The example representation includes eleven nodes, each denoted by an Arabic number from 1 to 11.

An edge in the resource graph 416 can represent a transition between two different configurations of the resource graph 416. In this case, the edge connects two different nodes in the resource graph 416. The edge representing the transition can be a directed edge where the transition occurs in one way only. In some cases, there can be two directed edges opposite each other between two nodes in order to provide a transition from a first node to a second node and another transition from the second node to the first node. That is, the two directed edges provide transitions in both directions between the first and second node. An edge in the resource graph also can represent an operation on a configuration, where the operation that does not change the configuration. In this case, the edge forms a loop that starts on a node and ends on that node. There can be one or more loops on a single node. In one example, each loop of the one or more loops represents a two-qubit gate between a particular pair of qubits. Simply for purposes of illustration, edges and associated operations (physical or quantum mechanical) are shown in FIG. 4B.

As mentioned, each parcel described in this disclosure refers to, and forms, an indivisible physical register that contains a defined number of confined/trapped atoms. In some architectures, the confined/trapped atoms are ions. Within those architectures, in some cases, each ion in a parcel is an ion that embodies a qubit. In other cases, the confined/trapped ions that form a parcel are a combination of at least one sympathetic cooling ion and multiple qubits. In other architectures, the confined/trapped atoms are neutral atoms, where each atom in a parcel is a neutral atom that embodies a qubit or serves a utility element. Simply for the sake of nomenclature, in this disclosure a parcel can be denoted by Pk, where k is an integer that indexes the parcel within a group of parcels configurable within the quantum hardware 430.

Regardless of whether the confined/trapped atoms that form a parcel are neutral or ionized, in some cases, the defined number of ions, the defined number of qubits, and the arrangement of ions designated as qubits is common across the multiple parcels that can be configured in the quantum hardware 430. The defined number of qubits can be equal to or greater than one. In such cases, the multiple parcels can be referred to as uniform parcels.

In other cases, the defined number of ions, the defined number of qubits, the arrangement of the ions designated as qubits, or a combination thereof is not uniform across the multiple parcels. As such, a first parcel of the multiple parcels contains a first defined number of qubits and a second parcel of the multiple parcels contains a second defined number of qubits, where the first number of qubits and the second respective number of qubits are different from one another. In such cases, the multiple parcels can be referred to as non-uniform parcels.

Regardless of the multiple parcels being uniform parcels or non-uniform parcels, at least one parcel has a single qubit. In addition, or in other cases, at least one parcel of the multiple parcels contains two or more qubits.

Simply as an illustration, the quantum hardware 430 can confine/trap N=64 ions, and the resource graph 416 can be defined in terms of a number of parcels M=4, each having N=16 ions, defining a set of parcels {P₁, P₂, P₃, P₄}. The disclosure is not limited in that respect, and more or fewer than 64 ions can be partitioned into M=4 parcels. Some ions can be configured as qubits for use in a quantum computation, and other ions can be configured as utility ions for utility purposes, such as spacing or cooling. As the number N increases, the number of ions in each parcel can be increased or the number of parcels can be increased, or a combination of both. As is described herein, increasing the number of qubits in a parcel can degrade quantum gate fidelity. Ultimately, N and M can be dictated by the confining capacity of the trapping apparatus 440 and the desired fidelity of quantum gates.

As mentioned, an edge in the resource graph 416 represents one of a physical operation or a quantum mechanical operation that can be applied to the functional elements (e.g., qubits and/or lasers) present in the configuration. The physical operation corresponds to a rearrangement of one or more parcels among multiple physical locations within the trapping apparatus 440. Such a rearrangement is defined by a temporal sequence of trapping potentials. Examples of a rearrangement of parcels include a swap of a first parcel and a second parcel, a merger of the first parcel and the second parcel, or a split of the first parcel into a third parcel and fourth parcel. In turn, the quantum mechanical operation can correspond to a quantum gate (e.g., a single-qubit gate or an entangling gate).

Nodes in the resource graph 416 can include metadata indicative of control parameters that define a configuration. That is, a control parameter defines a state variable of a resource (an electrode, a laser device, an acousto-optical modulator, etc.) within the quantum hardware 430. The control parameters can include physical control parameters and/or virtual control parameters. Here, a physical control parameter regulates, at least partially, the operation of equipment involved in a quantum computation. In addition, a virtual control parameter represents a physical property intended to be imparted on a register during the quantum computation. An example of the physical property includes a particular type of entanglement or a particular phase. The virtual control parameter is used in an abstract form for purposes of compilation of a quantum algorithm involved in the quantum computation. During computation, the virtual control parameter is ultimately decomposed into physical control parameters. Similarly, edges in the resource graph 416 can include metadata indicative of control parameters (physical or virtual) for an operation (e.g., Swap, Merge, Split, or Shift) that causes a transition from one node to another node. Such control parameters can define a sequence of state variables of a resource that permits causing a change in a configuration of the trapping apparatus 440. Accordingly, by defining values of state variables of resources of the quantum hardware 430, the resource graph 416 discretizes continuous-domain physical models of the resources, thus enabling both optimal control and efficient caching and retrieval when compiling quantum gates to execute on the hardware 430. That is, the resource graph 416 provides a finite number of nodes and edges, where each node and each edge can be identified with an integer hash key, for example. Such labels can be used to index a database of parameters for each node and/or edge. Thus, caching and retrieval is essentially optimal O(1) with respect to size of the resource graph 416.

For a particular architecture of the trapping apparatus 440 and other hardware of the quantum hardware 430, the resource graph 416 can be configured a priori during a configuration stage. The configuration stage can be implemented by a setup subsystem 420 that is functionally coupled to the control subsystem 410. To that end, the setup subsystem 420 includes computing resources, e.g., one or more processors, one or more memory devices, and similar resources. The memory device(s) include processor-accessible instructions that can be executed by the one or more processors, individually or in combination, to perform the configuration stage, in part or in its entirety. More specifically, the setup subsystem 420 can access configuration data 408 defining the architecture of the quantum hardware 430 or an update to the architecture. As an example, the configuration data 408 includes the number of parcels that the trapping apparatus 440 can support and/or types of operations (physical operations and quantum mechanical operations) that may be implemented within the quantum hardware 430. The configuration data 408 may be received from a computing device (not depicted in FIG. 4A) that may be functionally coupled to the setup subsystem 420. The configuration data 408 can be retained in one or multiple memory devices 406. The memory device(s) 406 also may include other data (not depicted) that permits operation of the quantum hardware. That other data may include, for example, calibration parameters for operation of one or more devices included in the quantum hardware 430. Thus, in some cases, the memory device(s) 406 also can be accessible to the control subsystem 410. In some cases, the setup subsystem 420 can be embodied in, or can include, the computer device 300 (FIG. 3) or a combination of computing devices, each having the functional elements of the computer device 300 (FIG. 3).

The setup subsystem 420, based on the configuration data, can update the resource graph 416. Updating the resource graph 416 can include creating a new instance of the resource graph 416 or modifying an existing instance of the resource graph 416. After updating the resource graph 416, the setup subsystem 420 can update the control subsystem 410 to retain the resource graph 416 in the memory device(s) 414 and/or to supply (e.g., expose or otherwise make available) the resource graph 416 to one or more components (e.g., a compiler module) present within the control subsystem 410 or functionally coupled thereto.

In response to obtaining the quantum program 404, at least one compute node (e.g., one or more computing devices) of the control subsystem 410 can access the resource graph 416. The compute node(s) can then generate a quantum circuit by mapping the quantum program to a walk of the resource graph 416. To generate the quantum circuit based on the quantum program 404, the compute node(s) can apply one or more graph optimization methods. For example, to transition from one arrangement of parcels to a different arrangement of parcels, an optimal series of operations can be represented as the shortest path through the resource graph 416. Weights defining a path can be assigned based on time, fidelity, and/or some other heuristic, using a Djikstra-type algorithm in some cases. As a result, the compute node(s) obtain an optimal or otherwise satisfactory executable program form, that as mentioned, is defined in terms of parcels. The parcels are in turn defined during configuration of the resource graph 416, as also mentioned. To implement the foregoing functionalities, each one of the compute node(s) includes computing resources, e.g., one or more processors, one or more memory devices, and similar resources. The memory device(s) include processor-accessible instructions that can be executed by the one or more processors, individually or in combination, to provide such functionalities. In some cases, the at least one compute node can be embodied in, or can include, the computer device 300 (FIG. 3). It is noted that disclosure is not limited to the at least one compute node being part of the control subsystem 410. Indeed, in some cases, the at least one compute node can be external and functionally coupled to the control subsystem 410.

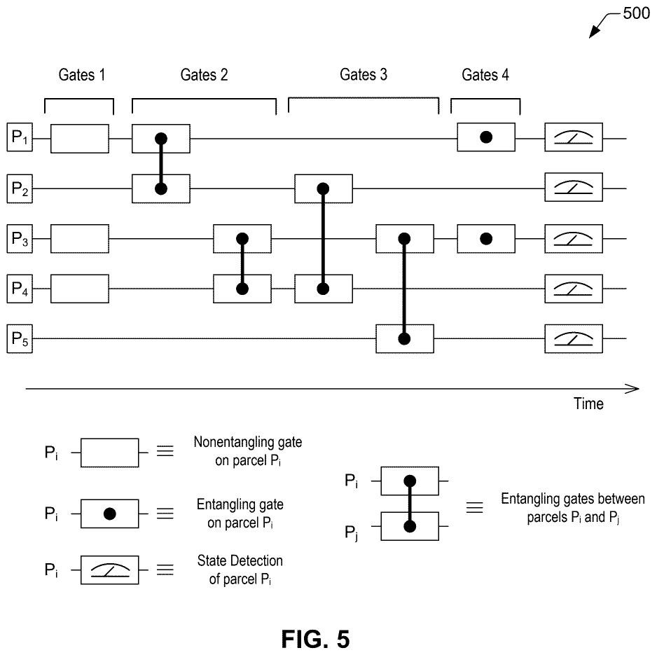

The quantum circuit that is generated is referred to as a compiled version of the quantum program 404, and is defined or cast in terms of the set {P₁, P₂, . . . , P_{Q}} of parcels that can be supported by the quantum hardware 430. Here, Q is a natural number greater than or equal to 1. The number of qubits contained in {P₁, P₂, . . . P_{Q}} can be the number of qubits N (≥1) that can be confined by the quantum hardware. Thus, the quantum computation corresponding to the compiled quantum circuit is an N-qubit computation (a single-qubit computation or a multi-qubit computation). However, because each parcel Pk (k=1, 2, . . . , Q) may include less than N qubits, the quantum mechanical operations present in the compiled quantum circuit can be performed with an abridged number of qubits, resulting in a greater fidelity than the fidelity otherwise obtained using a single qubit register spanning the N qubits. As an illustration, FIG. 5 is a schematic register diagram of an example of a compiled quantum circuit 500 in a scenario where Q=5 and a set of five example parcels {P₁, P₂, P₃, P₄, P₅}. In this example, each of those parcels has 16 qubits. The compiled quantum circuit 500 includes several quantum mechanical operations; namely, four entangling gates between respective pairs of parcels, two entangling gates on respective single parcels, and three single-parcel operations.

The control subsystem 410 can cause the quantum hardware 430 (FIG. 4A) to execute the quantum circuit. As mentioned, the quantum circuit is cast in terms of multiple parcels, each having a subset of the N qubits that can be configured within the trapping apparatus 440. Hence, in contrast to existing technologies, execution of the quantum circuit includes manipulation of the multiple parcels rather than performing operations (physical and/or quantum mechanical operations) in a single qubit register having the N qubits. The walk corresponding to the quantum circuit dictates the manner of manipulating the parcels. Therefore, the quantum circuit can be executed by traversing the walk. Such a traversal includes identifying a node in the walk and configuring a confinement section (or trap) of the trapping apparatus 440 according to the configuration defined in the node. The traversal further includes causing the quantum hardware 430 to implement one or more physical operations, defined by an edge linking the node to a second node. Then, in some cases, the traversal includes implementing a quantum operation (e.g., a single-qubit gate or an entangling gate) defined by an edge linking the second node to itself. Further traversal of the walk includes configuring the confinement section according to a third node identified by an edge that links the second node to the third node.

In other words, causing the quantum hardware 430 to execute a quantum circuit by traversing an appropriate walk of the resource graph 416 includes causing the quantum hardware 430 to transition between a configuration that arranges at least one parcel for a next quantum mechanical operation and another configuration for execution of a next quantum mechanical operation.

To execute a walk corresponding to a quantum circuit, the confinement section of the trapping apparatus 440 can be partitioned into multiple storage areas that may correspond to physical locations on the trapping apparatus 440. The multiple storage areas can be collectively referred to as a hard cache, and each storage area within a hard cache can be referred to as a slot. Stated differently, the hard cache is the set of all the slots for all of configurations of trapping potentials for electrodes in the trapping apparatus 440. The parcels are distributed across some or all of the slots in the hard cache. Each slot is configured to hold a defined number of parcels (e.g., one or more parcels). The defined number of parcels can be referred to as the slot capacity. A slot can either hold the defined number of parcels or can be empty. A slot holding its slot capacity of parcels is referred to as an occupied slot. A slot that is empty is referred to as an unoccupied slot. Slots that hold two or more parcels maintain the order of those parcels. Slot capacity need not be uniform across slots. In some cases, a first slot holds a first number of parcels and a second slot holds a second number of parcels, with the first number of parcels and the second number of parcels being different from one another. Further, there may be constraints, either from functional limitations or by design choices, that prevent one or more slots from being occupied when one or more other slots are occupied. For example, if a first slot configured to hold a single parcel has the same physical location on the trapping apparatus 440 as a second slot configured to hold two parcels, then only one of the first and second slots, or neither one of those, can be occupied at the same time.

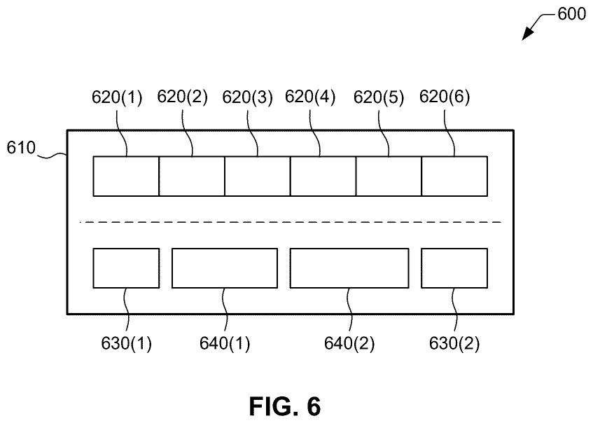

FIG. 6 is a schematic diagram 600 of an example of a hard cache in a QPU, in accordance with aspects of this disclosure. The example hard cache 610 can contain multiple slots. Specifically, the example hard cache 610 contains six slots 620(1) through 620(6), each of which can hold a single parcel, for example. In addition, the hard cache 610 also contains a first slot 630(1) and a second slot 630(2), each of which can hold a single parcel. Further, the example hard cache 610 also contains a third slot 640(1) and a fourth 640(2), each of which can hold two parcels. For the example hard cache 610, the horizontal position of a slot in the example hard cache 610 represents the physical position of the slot in the trapping apparatus 440. In this example, none of slots 620(1) through 620(6) can be occupied in case any of slots 630(1), 630(2), 640(1), or 640(2) are occupied. Similarly, none of slots 630(1), 630(2), 640(1), or 640(2) can be occupied in case any of slots 620(1) through 620(6) are occupied. This is graphically represented by having the first and second configurations of slots separated by a dashed line. While the slots in the hard cache 610 are shown as being composed of adjacent storage areas, the disclosure is not limited in that respect.

Each node in the resource graph 416 (FIG. 4A) represents or otherwise defines a specific distribution of the parcels {P₁, P₂, . . . P_{Q}} among the slots. Two nodes are not the same in case the nodes have a different arrangements of the parcels {P₁, P₂, . . . P_{Q}}, even for a same occupancy of slots in the hard cache. A first node and a second node different from the first node may share (e.g., may represent or define) a same arrangement of parcels {P₁, P₂, . . . P_{Q}} among slots. A node that represents or otherwise defines two or more parcels in a slot (for example, slot 640(1) (FIG. 6), the node also specifies the order of the two or more parcels stored in the slot. Two nodes may share a same distribution. For a particular node, all slots may be occupied or some of the slots may be occupied. Walking an edge of the resourced graph 416 can include transporting of the parcels between slots, merging two or more parcels into a slot, splitting two or more parcels present in a slot into separate slots, swapping two or more parcels, executing quantum gates within on one or more parcels, initializing one or more parcels, performing state detection on one or more parcels, relabeling parcels, or a combination of two or more of the foregoing operations.

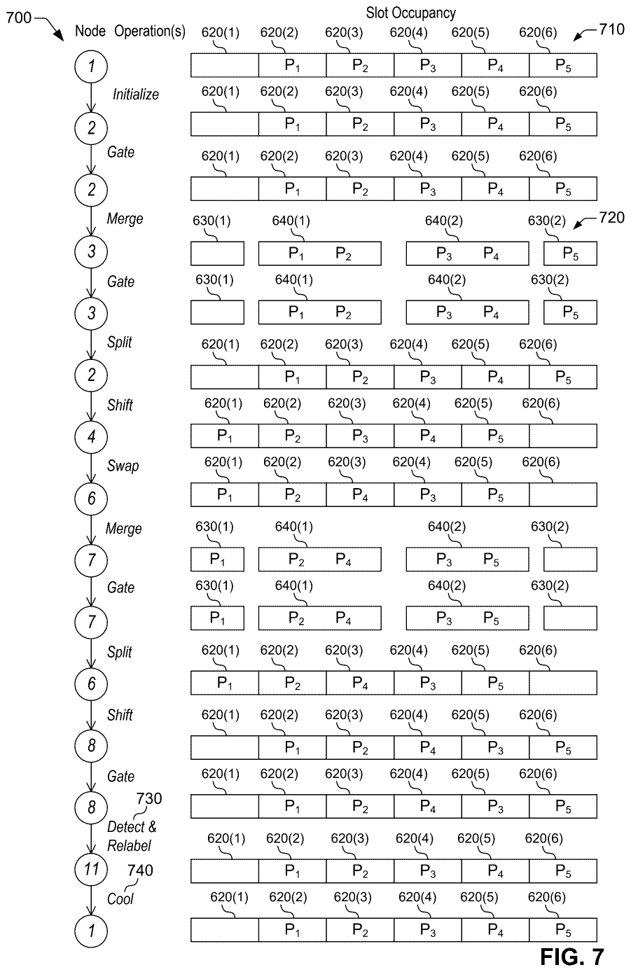

FIG. 7 illustrates an example of a walk 700 corresponding to the compiled quantum circuit 500 (FIG. 5), according to aspects described herein. The column labeled “Node” represents nodes from the example resource graph 416 that is shown in FIG. 4B. The column labeled “Slot Occupancy” represents the occupancy of slots in the example hard cache 610 (FIG. 6) by parcels P₁, P₂, P₃, P₄, and P₅. For the example resource graph 416 that is shown in FIG. 4B, each row in the “Slot Occupancy” column corresponds to a node in the “Node” column, with each row being shown as one of two grouping of slots: A first grouping 710 and a second grouping 720. The first grouping 710 includes slots 620(1) to 620(6), and the second grouping 720 includes slots 630(1), 640(1), 640(2), 630(2). In the first grouping 710, slots 630(1), 640(1), 640(2), 630(2) in the example hard cache 610 (FIG. 6) are empty. In the second grouping 720, slots 620(k), with k=1, 2, 3, 4, 5, and 6, in the example hard cache 610 (FIG. 6) are empty.

Each edge connecting a pair of consecutive nodes in the “Node” column represents an edge connecting a same pair of nodes in the example resource graph 416 shown in FIG. 4B. Some of the edges include a physical operation—Swap, Shift, Merge, or Split, in this example—and other edges include a quantum mechanical operation—Initialize, Gate, Detect & Relabel, and Cool, in this example.

The physical operations of the walk 700 are represented by changes in the occupancy of slots 610(2) to 620(6) and slots 630(1), 640(1), 640(2), 630(2). The Merge operation causes parcels P₁ and P₂ to occupy slot 640(1), and parcels P₃ and P₄ to occupy slot 640(2), and also causes parcel P₅ to transition from occupying slot 620(6) to occupying slot 630(2). The Relabel portion of the Detect and Relabel operation 730 does not cause the parcels to move between physical locations, but causes respective labels of the parcels to change in preparation for reuse of the parcels in execution of another quantum computation. Transition from node 11 back to node 1 in FIG. 7 is accomplished by performing a Cool operation 740.

Back to FIG. 4A, as part of execution of the quantum circuit, the quantum hardware 430 is directed to perform multiple measurement cycles 424 (or “shots”) in order to accumulate statistics and obtain a result of the computation (e.g., a multi-qubit computation) defined by the quantum program 404. The control subsystem 410 can receive data 428 defining outcomes of one or more shots.

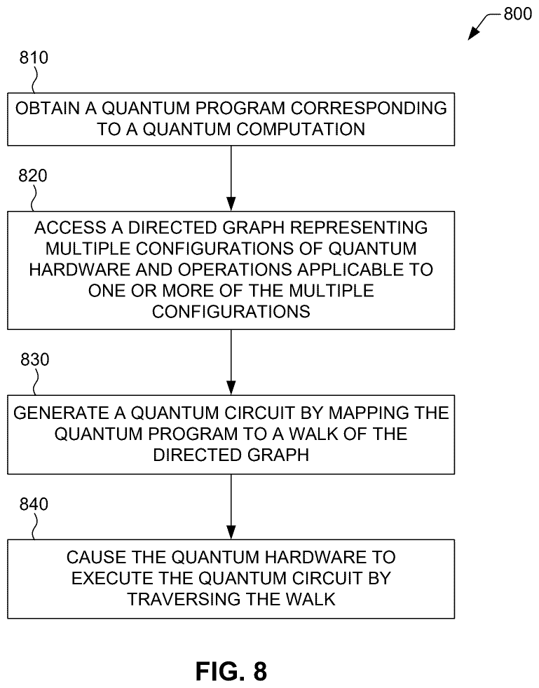

FIG. 8 is a flowchart of an example of a method for compiling and executing a quantum computation a configurable QPU, in accordance with aspects of this disclosure. One or more classical compute nodes can implement the example method 800. The classical compute node(s) can be part of a control system included in a QIP system having the configurable QPU. To that end, as is described herein, each of the classical compute node(s) includes computing resources, e.g., one or more processors, one or more memory devices, and similar resources. The memory device(s) include processor-accessible instructions that can be executed by the one or more processors, individually or in combination, to perform the example method 800, in part or in its entirety. For example, the control subsystem 410 (FIG. 4A) can implement the example method 800 in part or in its entirety. As is described herein, in some cases, the control subsystem 410 can be embodied in, or can include, the computer device 300 (FIG. 3) or a combination of computing devices, each having the functional elements of the computer device 300 (FIG. 3).

At block 810, the control system can obtain a quantum program corresponding to a quantum computation. The quantum computation can be a defined computation (e.g., a multi-qubit computation) corresponding to a quantum algorithm, such as a variational quantum algorithm, a machine-learning algorithm, a Fourier transform algorithm, or the like.

At block 820, the control system can access a directed graph representing multiple configurations and operations applicable to one or more of the multiple configurations. A node in the directed graph represents a configuration of the quantum hardware. The configuration of the quantum hardware includes the arrangement of multiple parcels across slots that can be configured within the quantum hardware. As mentioned, each parcel of the multiple parcels forms an indivisible physical register that contains a defined number of atoms (ionized or neutral). The slots can be configured within a hard cache. An edge in the directed graph represents one or more physical operations, one or more quantum mechanical operations, or a combination of physical and quantum mechanical operations. An example of the directed graph is the resource graph 416 described herein.

At block 830, the control system can generate a quantum circuit by mapping the quantum program to a walk of the directed graph. The quantum circuit that is generated is cast in terms of the multiple parcels.

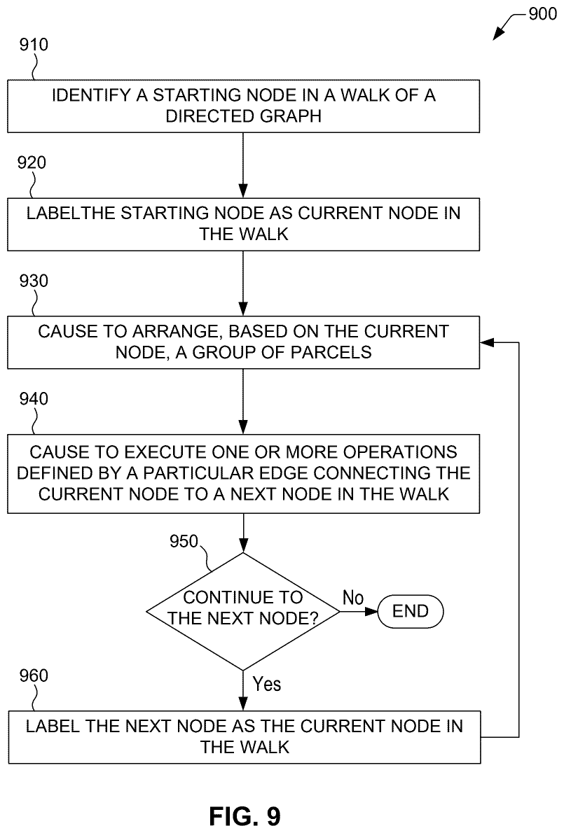

At block 840, the control system can cause the quantum hardware to execute the quantum circuit by traversing the walk of the directed graph. The control system can cause the quantum hardware to traverse the walk by implementing the example method 900 illustrated in FIG. 9 as described hereinbelow. More specifically, at block 910, the control system can identify a starting node in a walk of the directed graph. The starting node defines the group of parcels. In one example, the walk can be the walk 700 (FIG. 7) and the group of parcels consists of P₁, P₂, P₃, P₄, and P₅. At block 920, the control system can label the starting node as current node in the walk. At block 930, the control system can cause to arrange, based on the current node, a group of parcels among slots within a hard cache as is described herein. In one example, causing to arrange the group of parcels may include causing to implement one or more a temporal sequences of trapping potentials in a trapping apparatus (e.g., trapping apparatus 440). At block 940, the control system can cause to execute one or more operations defined by a particular edge connecting the current node to a next node in the walk. As is described herein, the one or more operations include a physical operation, a quantum mechanical operation, or a combination of both. At block 950, the control system can determine if the walk continues to the next node. In response to a negative determination, the control system terminates the traversal of the walk. In response to an affirmative determination, the flow of the example method 900 continues to block 960, where the control system can label the next node as the current node in the walk. The flow of the example method 900 continues from block 960 to block 920. The example method 900 thus continues causing the quantum hardware to transition between different parcel arrangements and related operation(s) until the one or more operations corresponding to a final node in the walk are executed.

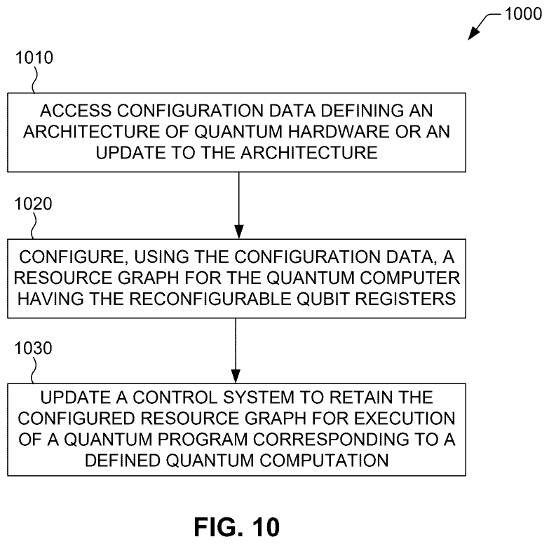

FIG. 10 is a flowchart of an example of a method for providing a resource graph for a quantum computer having reconfigurable qubit registers, in accordance with aspects of this disclosure. One or more classical compute nodes can implement the example method 1000. The classical compute node(s) can be part of a setup system that may be included in or functionally coupled with a QIP system having a configurable QPU as is described herein. For example, the setup subsystem 420 (FIG. 4A) can implement the example method 1000 in part or in its entirety. To that end, as is described herein, the setup subsystem 420 includes computing resources, e.g., one or more processors, one or more memory devices, and similar resources. The memory device(s) include processor-accessible instructions that can be executed by the one or more processor, individually or in combination, to perform the example method 1000, in part or in its entirety. As is described herein, in some cases, setup subsystem 420 can be embodied in, or can include, the computer device 300 (FIG. 3) or a combination of computing devices, each having the functional elements of the computer device 300 (FIG. 3).

At block 1010, the setup system can access configuration data defining an architecture of quantum hardware (e.g., quantum hardware 430 (FIG. 4A) or an update to the architecture. As an example, the configuration data includes the number of parcels that a trapping apparatus can support and/or types of operations (physical operations and quantum mechanical operations) that may be implemented within the quantum hardware. The trapping apparatus may be part of the quantum hardware. The quantum hardware can form or can be part of a quantum computer having reconfigurable qubit registers, in accordance with aspects described herein.

At block 1020, the setup system can configure, using the configuration data, a resource graph for the quantum computer having the reconfigurable qubit registers. Configuring the resource graph may include configuring a directed graph representing multiple configurations of functional elements that constitute quantum hardware of the quantum computer, one or more transitions between the functional elements, and one or more operations configured to be applied to the functional elements. The one or more transitions include transport of one or more parcels to dynamically reconfigure connectivity, laser cooling, state preparation, detection, or a combination thereof, each parcel of the one or more parcels forming an indivisible physical register that contains a defined number of ions. Each parcel of the multiple parcels comprises one or more qubits, one or more utility ions, or a combination thereof. The one or more operations may include one-qubit gate operations and two-qubit gate operations, laser cooling, state preparation, state detection, or a combination thereof. An example of the directed graph is the resource graph 416 described herein.

In addition, or in some cases, configuring the directed graph may include configuring a node of the directed graph, the node representing a configuration of the quantum hardware. Further, or in other cases, configuring the directed graph may further include configuring an edge of the directed graph, the edge representing a transition between two different configurations of the directed graph.

At block 1030, the setup system can update a control system (e.g., the control subsystem 410 (FIG. 4A)) to retain the configured resource graph for execution of a quantum program corresponding to a defined quantum computation, the control system functionally coupled to the quantum computer.

By updating a resource graph in accordance with the example method 1000, a quantum computer having reconfigurable registers can execute quantum computations with a larger number of ionic qubits (or, in some cases, other types of qubits) without causing degradation of quantum fidelity. Thus, providing a resource graph in accordance with aspects of this disclosure improves quantum computations relative to those carried out in at least some of the existing quantum information processing systems.

Various example embodiments emerge from the foregoing description and annexed drawings, as is conveyed by the following clauses.

Clause 1. A computer-implemented method comprising, obtaining a quantum program corresponding to a defined quantum computation; accessing a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generating a quantum circuit by mapping the quantum program to a walk of the directed graph; and causing the quantum hardware to execute the quantum circuit by traversing the walk.

Clause 2. The computer-implemented method of clause 1, wherein the configuration of the quantum hardware includes a spatial arrangement of multiple parcels configured in the quantum hardware, each parcel forming an indivisible physical register that contains a defined number of ions.

Clause 3. The computer-implemented method of clause 2, each parcel of the multiple parcels comprises one or more qubits, one or more utility ions, or a combination thereof.

Clause 4. The computer-implemented method of clause 2, wherein a physical operation of the one or more physical operations corresponds to a rearrangement of one or more parcels among multiple physical locations, wherein the rearrangement is defined by a temporal sequence of trapping potentials.

Clause 5. The computer-implemented method of clause 3, wherein the rearrangement is one of a swap of a first parcel and a second parcel, a merger of the first parcel and the second parcel, or a split of the first parcel into a third parcel and a fourth parcel.

Clause 6. The computer-implemented method of clause 2, wherein the one or more quantum mechanical operations corresponds to respective quantum gates.

Clause 7. The computer-implemented method of clause 2, wherein the quantum hardware comprises a trapping apparatus comprising a hard cache having one or more slots, each one of the one or more slots configured to hold at least one parcel.

Clause 8. The computer-implemented method of clause 2, wherein the traversing the walk comprises: arranging, based on a current node in the walk, one or more parcels; executing one or more physical operations, one or more quantum mechanical operations, or a combination of the one or more physical operations and the one or more quantum mechanical operations defined by a particular edge connecting the current node to a next node of the walk; determining that the walk continues to the next node; and labeling the next node as the current node.

Clause 9. The computer-implemented method of clause 2, wherein the defined number of ions is common across the multiple parcels and is equal to or greater than one.

Clause 10. The computer-implemented method of clause 2, wherein a first parcel of the multiple parcels contains a first defined number of qubits and a second parcel of the multiple parcels contains a second defined number of qubits, the first defined number of qubits and the second defined number of qubits being different from one another.

Clause 11. The computer-implemented method of clause 2, wherein at least one parcel has a single qubit.

Clause 12. The computer-implemented method of clause 2, wherein at least one parcel of the multiple parcels contains two or more qubits.

Clause 13. The computer-implemented method of clause 7, wherein a first slot of the one or more slots holds none of the multiple parcels.

Clause 14. The computer-implemented method of clause 7, wherein the one or more slots comprise multiple slots, and wherein a first slot of the multiple slots holds none of the multiple parcels and a second slot of the multiple slots holds at least one of the multiple parcels.

Clause 15. The computer-implemented method of clause 7, wherein each slot of the one or more slots holds a same number of parcels.

Clause 16. The computer-implemented method of clause 7, wherein a first slot of the one or more slots holds a first number of parcels and a second slot of the one or more slots holds a second number of parcels, the first number of parcels and the second number of parcels being different from one another.

Clause 17. A system, comprising: at least one memory device; and at least one processor functionally coupled to the at least one memory device and configured, individually or in combination, at least to: obtain a quantum program corresponding to a defined quantum computation; access a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generate a quantum circuit by mapping the quantum program to a walk of the directed graph; and cause the quantum hardware to execute the quantum circuit by traversing the walk.

Clause 18. The system of clause 17, wherein the configuration of the quantum hardware includes a spatial arrangement of multiple parcels configured in the quantum hardware, each parcel forming an indivisible physical register that contains a defined number of ions.

Clause 19. The system of clause 18, each parcel of the multiple parcels comprises one or more qubits, one or more utility ions, or a combination thereof.

Clause 20. The system of clause 18, wherein the physical operation corresponds to a rearrangement of one or more parcels among multiple physical locations, wherein the rearrangement is defined by a temporal sequence of trapping potentials.

Clause 21. The system of clause 19, wherein the rearrangement is one of a swap of a first parcel and a second parcel, a merger of the first parcel and the second parcel, or a split of the first parcel into a third parcel and a fourth parcel.

Clause 22. The system of clause 18, wherein the one or more quantum mechanical operations corresponds to respective quantum gates.

Clause 23. The system of clause 18, wherein the quantum hardware comprises a trapping apparatus comprising a hard cache having one or more slots, each one of the one or more slots configured to hold at least one parcel.

Clause 24. The system of clause 18, wherein to traverse the walk, the at least one processor is further configured to: arrange, based on a current node in the walk, one or more parcels; execute one or more physical operations, one or more quantum mechanical operations, or a combination of the one or more physical operations and the one or more quantum mechanical operations defined by a particular edge connecting the current node to a next node of the walk; determine that the walk continues to the next node; and label the next node as the current node.

Clause 25. The system of clause 18, wherein the defined number of qubits is common across the multiple parcels and is equal to or greater than one.

Clause 26. The system of clause 18, wherein a first parcel of the multiple parcels contains a first defined number of qubits and a second parcel of the multiple parcels contains a second defined number of qubits, the first number of qubits and the second respective number of qubits being different from one another.

Clause 27. The system of clause 18, wherein at least one parcel has a single qubit.

Clause 28. The system of clause 18, wherein at least one parcel of the multiple parcels contains two or more qubits.

Clause 29. The system of clause 23, wherein a first slot of the one or more slots holds none of the multiple parcels.

Clause 30. The system of clause 23, wherein the one or more slots comprise multiple slots, and wherein a first slot of the multiple slots holds none of the multiple parcels and a second slot of the one or multiple slots holds at least one of the multiple parcels.

Clause 31. The system of clause 23, wherein each slot of the one or more slots holds a same number of parcels.

Clause 32. The system of clause 22, wherein a first slot of the one or more slots holds a first number of parcels and a second slot of the one or more slots holds a second number of parcels, the first number of parcels and the second number of parcels being different from one another.

Clause 33. A non-transitory computer readable medium containing program instructions for causing a classical computer to perform or facilitate operations comprising: obtaining a quantum program corresponding to a defined quantum computation; accessing a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generating a quantum circuit by mapping the quantum program to a walk of the directed graph. causing the quantum hardware to execute the quantum circuit by traversing the walk.

Clause 34. The non-transitory computer readable medium of clause 33, wherein the configuration of the quantum hardware includes a spatial arrangement of multiple parcels configured in the quantum hardware, each parcel forming an indivisible physical register that contains a defined number of ions.

Clause 35. The non-transitory computer readable medium of clause 34, each parcel of the multiple parcels comprises one or more qubits, one or more utility ions, or a combination thereof.

Clause 36. The non-transitory computer readable medium of clause 34, wherein the physical operation corresponds to a rearrangement of one or more parcels among multiple physical locations, wherein the rearrangement is defined by a temporal sequence of trapping potentials.

Clause 37. The non-transitory computer readable medium of clause 35, wherein the rearrangement is one of a swap of a first parcel and a second parcel, a merger of the first parcel and the second parcel, or a split of the first parcel into a third parcel and a fourth parcel.

Clause 38. The non-transitory computer readable medium of clause 34, wherein the one or more quantum mechanical operations corresponds to respective quantum gates.

Clause 39. The non-transitory computer readable medium of clause 34, wherein the quantum hardware comprises a trapping apparatus comprising a hard cache having one or more slots, each one of the one or more slots configured to hold at least one parcel.

Clause 40. The non-transitory computer readable medium of clause 34, wherein the traversing the walk comprises: arranging, based on a current node in the walk, one or more parcels; executing one or more physical operations, one or more quantum mechanical operations, or a combination of the one or more physical operations and the one or more quantum mechanical operations defined by a particular edge connecting the current node to a next node of the walk; determining that the walk continues to the next node; and labeling the next node as the current node.

Clause 41. The non-transitory computer readable medium of clause 34, wherein the defined number of qubits is common across the multiple parcels and is equal to or greater than one.

Clause 42. The non-transitory computer readable medium of clause 34, wherein a first parcel of the multiple parcels contains a first defined number of qubits and a second parcel of the multiple parcels contains a second defined number of qubits, the first number of qubits and the second respective number of qubits being different from one another.

Clause 43. The non-transitory computer readable medium of clause 34, wherein at least one parcel has a single qubit.

Clause 44. The non-transitory computer readable medium of clause 34, wherein at least one parcel of the multiple parcels contains two or more qubits.

Clause 45. The non-transitory computer readable medium of clause 39, wherein a first slot of the one or more slots holds none of the multiple parcels.

Clause 46. The non-transitory computer readable medium of clause 39, wherein the one or more slots comprise multiple slots, and wherein a first slot of the multiple slots holds none of the multiple parcels and a second slot of the one or multiple slots holds at least one of the multiple parcels.

Clause 47. The non-transitory computer readable medium of clause 39, wherein each slot of the one or more slots holds a same number of parcels.

Clause 48. The non-transitory computer readable medium of clause 38, wherein a first slot of the one or more slots holds a first number of parcels and a second slot of the one or more slots holds a second number of parcels, the first number of parcels and the second number of parcels being different from one another.

Clause 49. A quantum information processing (QIP) system, comprising: hardware configured to support multiple parcels within a confinement section of the hardware; each one of the multiple parcels configured to include at least one qubit; and a classical computing system functionally coupled to the hardware and comprising at least one processor configured, individually or in combination, at least to: obtain a quantum program corresponding to a defined quantum computation; access a directed graph representing multiple configurations of quantum hardware and operations applicable to one or more of the multiple configurations, wherein a node in the directed graph represents a configuration of the quantum hardware, and wherein an edge in the directed graph represents one or more physical operations, one or more quantum mechanical operations, or a combination of physical operations and quantum mechanical operations; generate a quantum circuit by mapping the quantum program to a walk of the directed graph; and cause the quantum hardware to execute the quantum circuit by traversing the walk.

Clause 50. The QIP system of clause 49, wherein the configuration of the hardware includes a spatial arrangement of multiple parcels configured in the quantum hardware, each parcel forming an indivisible physical register that contains a defined number of ions.

Clause 51. The QIP system of clause 50, each parcel of the multiple parcels comprises one or more qubits, one or more utility ions, or a combination thereof.

Clause 52. The QIP system of clause 50, wherein the physical operation corresponds to a rearrangement of one or more parcels among multiple physical locations, wherein the rearrangement is defined by a temporal sequence of trapping potentials.

Clause 53. The QIP system of clause 51, wherein the rearrangement is one of a swap of a first parcel and a second parcel, a merger of the first parcel and the second parcel, or a split of the first parcel into a third parcel and a fourth parcel.

Clause 54. The QIP system of clause 50, wherein the one or more quantum mechanical operations corresponds to respective quantum gates.

Clause 55. The QIP system of clause 50, wherein the hardware comprises a trapping apparatus comprising a hard cache having one or more slots, each one of the one or more slots configured to hold at least one parcel.

Clause 56. The QIP system of clause 50, wherein to traverse the walk, the at least one processor is further configured to: arrange, based on a current node in the walk, one or more parcels; execute one or more physical operations, one or more quantum mechanical operations, or a combination of the one or more physical operations and the one or more quantum mechanical operations defined by a particular edge connecting the current node to a next node of the walk; determine that the walk continues to the next node; and label the next node as the current node.

Clause 57. The QIP system of clause 50, wherein the defined number of qubits is common across the multiple parcels and is equal to or greater than one.

Clause 58. The QIP system of clause 50, wherein a first parcel of the multiple parcels contains a first defined number of qubits and a second parcel of the multiple parcels contains a second defined number of qubits, the first number of qubits and the second respective number of qubits being different from one another.

Clause 59. The QIP system of clause 50, wherein at least one parcel has a single qubit.

Clause 60. The QIP system of clause 50, wherein at least one parcel of the multiple parcels contains two or more qubits.

Clause 61. The QIP system of clause 55, wherein a first slot of the one or more slots holds none of the multiple parcels.

Clause 62. The QIP system of clause 55, wherein the one or more slots comprise multiple slots, and wherein a first slot of the multiple slots holds none of the multiple parcels and a second slot of the one or multiple slots holds at least one of the multiple parcels.

Clause 63. The QIP system of clause 55, wherein each slot of the one or more slots holds a same number of parcels.

Clause 64. The QIP system of clause 54, wherein a first slot of the one or more slots holds a first number of parcels and a second slot of the one or more slots holds a second number of parcels, the first number of parcels and the second number of parcels being different from one another.

Clause 65. A computer-implemented method, comprising: configuring a resource graph for a quantum computer having reconfigurable qubit registers; and updating a control system to retain the configured resource graph for execution of a quantum program corresponding to a defined quantum computation, the control system functionally coupled to the quantum computer.

Clause 66. The computer-implemented method of clause 65, wherein configuring the resource graph comprises configuring a directed graph representing multiple configurations of functional elements that constitute quantum hardware of the quantum computer, one or more transitions between the functional elements, and one or more operations configured to be applied to the functional elements.

Clause 67. The computer-implemented method of clause 66, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

Clause 68. The computer-implemented method of clause 67, wherein each parcel of the one or more parcels comprises one or more qubits, one or more utility ions, or a combination thereof.

Clause 69. The computer-implemented method of clause 66, wherein the one or more operations include one-qubit gate operations and two-qubit gate operations, laser cooling, state preparation, state detection, or a combination thereof.

Clause 70. The computer-implemented method of clause 66, wherein configuring the directed graph comprises configuring a node of the directed graph, the node representing a configuration of the quantum hardware.

Clause 71. The computer-implemented method of clause 70, wherein configuring the directed graph further comprises configuring an edge of the directed graph, the edge representing a transition between two different configurations of the directed graph.

Clause 72. A non-transitory computer readable medium containing program instructions for causing a classical computer to perform or facilitate operations comprising: configuring of a resource graph for a quantum computer having reconfigurable qubit registers; and updating a control system to retain the configured resource graph for execution of a quantum program corresponding to a defined quantum computation, the control system functionally coupled to the quantum computer.

Clause 73. The non-transitory computer readable medium of clause 72, wherein configuring the resource graph comprises configuring a directed graph representing multiple configurations of functional elements that constitute quantum hardware of the quantum computer, one or more transitions between the functional elements, and one or more operations configured to be applied to the functional elements.

Clause 74. The non-transitory computer readable medium of clause 73, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

Clause 75. The non-transitory computer readable medium of clause 74, wherein each parcel of the one or more parcels comprises one or more qubits, one or more utility ions, or a combination thereof.

Clause 76. The non-transitory computer readable medium of clause 73, wherein the one or more operations include one-qubit gate operations and two-qubit gate operations, laser cooling, state preparation, state detection, or a combination thereof.

Clause 77. The non-transitory computer readable medium of clause 73, wherein configuring the directed graph comprises configuring a node of the directed graph, the node representing a configuration of the quantum hardware.

Clause 78. The non-transitory computer readable medium of clause 77, wherein configuring the directed graph comprises configuring an edge of the directed graph, the edge representing a transition between two different configurations of the directed graph.

Clause 79. A classical computing system, comprising: at least one memory device; and at least one processor functionally coupled to the at least one memory device and configured, individually or in combination, at least to: configure a resource graph for a quantum computer having reconfigurable qubit registers; and update a control system to retain the configured resource graph for execution of a quantum program corresponding to a defined quantum computation, the control system functionally coupled to the quantum computer.

Clause 80. The classical computing system of clause 79, wherein configuring the resource graph comprises configuring a directed graph representing multiple configurations of functional elements that constitute quantum hardware of the quantum computer, one or more transitions between the functional elements, and one or more operations configured to be applied to the functional elements.

Clause 81. The classical computing system of clause 80, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

Clause 82. The classical computing system of clause 81, wherein each parcel of the one or more parcels comprises one or more qubits, one or more utility ions, or a combination thereof.

Clause 83. The classical computing system of clause 81, wherein the one or more operations include one-qubit gate operations and two-qubit gate operations, laser cooling, state preparation, state detection, or a combination thereof.

Clause 84. The classical computing system of clause 80, wherein configuring the directed graph comprises, configuring a node of the directed graph, the node representing a configuration of the quantum hardware; and configuring an edge of the directed graph, the edge representing a transition between two different configurations of the directed graph.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including:
matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” “platform,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches, and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method, comprising:
configuring a resource graph for a quantum computer having reconfigurable qubit registers; and
updating a control system to retain the configured resource graph for execution of a quantum program corresponding to a defined quantum computation, the control system functionally coupled to the quantum computer.

2. The computer-implemented method of claim 1, wherein configuring the resource graph comprises configuring a directed graph representing multiple configurations of functional elements that constitute quantum hardware of the quantum computer, one or more transitions between the functional elements, and one or more operations configured to be applied to the functional elements.

3. The computer-implemented method of claim 2, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

4. The computer-implemented method of claim 3, wherein each parcel of the one or more parcels comprises one or more qubits, one or more utility ions, or a combination thereof.

5. The computer-implemented method of claim 2, wherein the one or more operations include one-qubit gate operations and two-qubit gate operations, laser cooling, state preparation, state detection, or a combination thereof.

6. The computer-implemented method of claim 2, wherein configuring the directed graph comprises configuring a node of the directed graph, the node representing a configuration of the quantum hardware.

7. The computer-implemented method of claim 6, wherein configuring the directed graph further comprises configuring an edge of the directed graph, the edge representing a transition between two different configurations of the directed graph.

8. A non-transitory computer readable medium containing program instructions for causing a classical computer to perform or facilitate operations comprising:
configuring of a resource graph for a quantum computer having reconfigurable qubit registers; and
updating a control system to retain the configured resource graph for execution of a quantum program corresponding to a defined quantum computation, the control system functionally coupled to the quantum computer.

9. The non-transitory computer readable medium of claim 8, wherein configuring the resource graph comprises configuring a directed graph representing multiple configurations of functional elements that constitute quantum hardware of the quantum computer, one or more transitions between the functional elements, and one or more operations configured to be applied to the functional elements.

10. The non-transitory computer readable medium of claim 9, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

11. The non-transitory computer readable medium of claim 10, wherein each parcel of the one or more parcels comprises one or more qubits, one or more utility ions, or a combination thereof.

12. The non-transitory computer readable medium of claim 9, wherein the one or more operations include one-qubit gate operations and two-qubit gate operations, laser cooling, state preparation, state detection, or a combination thereof.

13. The non-transitory computer readable medium of claim 9, wherein configuring the directed graph comprises configuring a node of the directed graph, the node representing a configuration of the quantum hardware.

14. The non-transitory computer readable medium of claim 13, wherein configuring the directed graph comprises configuring an edge of the directed graph, the edge representing a transition between two different configurations of the directed graph.

15. A classical computing system, comprising:
at least one memory device; and
at least one processor functionally coupled to the at least one memory device and configured, individually or in combination, at least to:
configure a resource graph for a quantum computer having reconfigurable qubit registers; and
update a control system to retain the configured resource graph for execution of a quantum program corresponding to a defined quantum computation, the control system functionally coupled to the quantum computer.

16. The classical computing system of claim 15, wherein configuring the resource graph comprises configuring a directed graph representing multiple configurations of functional elements that constitute quantum hardware of the quantum computer, one or more transitions between the functional elements, and one or more operations configured to be applied to the functional elements.

17. The classical computing system of claim 16, wherein the one or more transitions include transport of one or more parcels to dynamically reconfigure connectivity, laser cooling, state preparation, detection, or a combination thereof, each parcel of the one or more parcels forming an indivisible physical register that contains a defined number of ions.

18. The classical computing system of claim 17, wherein each parcel of the one or more parcels comprises one or more qubits, one or more utility ions, or a combination thereof.

19. The classical computing system of claim 17, wherein the one or more operations include one-qubit gate operations and two-qubit gate operations, laser cooling, state preparation, state detection, or a combination thereof.

20. The classical computing system of claim 16, wherein configuring the directed graph comprises,
configuring a node of the directed graph, the node representing a configuration of the quantum hardware; and
configuring an edge of the directed graph, the edge representing a transition between two different configurations of the directed graph.
